(19) United States
(12) Patent Application Publication
(10) Pub. No.: US 2022/0128854 A1
(43) Pub. Date: Apr. 28, 2022

(54) DISPLAY PANEL AND MANUFACTURING METHOD THEREOF

(71) Applicant: Wuhan China Star Optoelectronics Technology Co., Ltd., Wuhan (CN)

(72) Inventor: Yong YANG, Wuhan (CN)

(73) Assignee: Wuhan China Star Optoelectronics Technology Co., Ltd., Wuhan (CN)

(21) Appl. No.: 16/772,816

(22) PCT Filed: Nov. 19, 2019
(86) PCT No.: PCT/CN2019/119434

§ 371 Date: Jun. 15, 2020

(30) Foreign Application Priority Data
Oct. 28, 2019 (CN) 201911028216.8

(51) Int. Cl. G02F 1/1339; G02F 1/1341; G02F 1/1347

(52) U.S. Cl. CPC G02F 1/13398; G02F 1/13394; G02F 1/133514; G02F 1/1347; G02F 1/1341

(57) ABSTRACT

The present disclosure discloses a display panel and a manufacturing method thereof. The present disclosure adopts a polymer retaining wall instead of the existing frame sealant, to isolate liquid crystal molecules in the first display area from liquid crystal molecules in the second display area, and uses photomask exposure for polymerization to form a shape of the retaining wall, so that a thickness of the retaining wall is less than 50 micrometers, and the black border effect at the boundary between the first display area and the second display area can be visually eliminated.

### BACKGROUND OF INVENTION

### Field of Invention

The present disclosure relates to a field of display technology, and in particular, to a display panel and a manufacturing method thereof.

### Description of Prior Art

With continuous development and advancement of low-temperature polycrystalline silicon (LTPS) small-size display technology, full-screen technology has become the mainstream technology in the mobile phone market, and is derived into endlessly emerged full-screen technology, such as a notch full-screen, a widow's peak full-screen, and a blind via full-screen, whose ever-increasing screen-to-body ratio of mobile phones continues to push the full-screen technology to the extreme.

However, the above three technologies all need a hollowing or notching process on a partial area, so that a camera area is exposed for taking pictures, and therefore, a true full-screen display effect cannot be achieved. For this reason, people have also tried to further increase the screen-to-body ratio by providing the camera area with a display function. In order to control the display function of the camera area independently, a liquid crystal cell of polymer network liquid crystal (PNLC) type and/or a polymer dispersed liquid crystal (PDLC) type is usually used in the camera area, such that the liquid crystal cell controls photographing and hiding of a camera, wherein the liquid crystal cell needs to be separated from a liquid crystal cell of a main screen display area by a frame sealant, but the frame sealant will cause a black border between the camera display area and the main screen display area, impacting the display effect.

In view of this, there is an urgent need to provide a means to solve the above problems.

In order to control the display function of the camera area independently, a liquid crystal cell of polymer network liquid crystal (PNLC) type and/or a polymer dispersed liquid crystal (PDLC) type is usually used in the camera area, such that the liquid crystal cell controls photographing and hiding of a camera, wherein the liquid crystal cell needs to be separated from a liquid crystal cell of a main screen display area by a frame sealant, but the frame sealant will cause a black border between the camera display area and the main screen display area, impacting the display effect.

### SUMMARY OF INVENTION

In order to solve the above problems, embodiments of the present disclosure provide a display panel and a manufacturing method thereof, which can effectively solve a problem of a black border at a boundary between a first display area (such as a main screen display area) and a second display area (such as a camera display area).

According to an aspect of the present disclosure, an embodiment of the present disclosure provides a display panel, including: a liquid crystal layer, including a first liquid crystal layer and a second liquid crystal layer, wherein the first liquid crystal layer is spaced from the second liquid crystal layer through a retaining wall; an area where the first liquid crystal layer is located corresponds to a first display area of the display panel, and an area where the second liquid crystal layer is located corresponds to a second display area of the display panel; and wherein a width of a vertical projection of the retaining wall in a direction of the liquid crystal layer is smaller than a preset width threshold.

Further, the retaining wall is made of a material including non-polar or weakly polar aromatic organic molecules.

Further, the aromatic organic molecules are methacrylate-based oligomers and 4,4′-di[6-(acryloyloxy)hexyloxy]biphenyl.

Further, the display panel further includes: an array substrate; and a color filter substrate, the color filter substrate is disposed opposite to the array substrate; the liquid crystal layer is sandwiched between the array substrate and the color filter substrate; the liquid crystal layer is divided into the first display area and the second display area by the retaining wall, wherein the area enclosed by the retaining wall is the second display area.

Further, a shape enclosed by the retaining wall is selected from one of a circle, a semi-arc and a trapezoid.

Further, the preset width threshold is smaller than or equal to 50 micrometers.

According to another aspect of the present disclosure, an embodiment of the present disclosure further provides a method of manufacturing a display panel, including the following steps: providing an array substrate; filling a first display area of the array substrate with a first liquid crystal to form a first liquid crystal layer; coating monomers at a boundary between the first display area and a second display area of the array substrate; placing the array substrate in an electric field; irradiating the boundary to polymerize the monomers to form a retaining wall; and filling the second display area with a second liquid crystal to form a second liquid crystal layer.

Further, the retaining wall is made of a material including non-polar or weakly polar aromatic organic molecules, and the aromatic organic molecules are methacrylate-based oligomers and 4,4′-di[6-(acryloyloxy)hexyloxy]biphenyl.

Further, the step of irradiating the boundary to polymerize the monomers to form a retaining wall further includes:

removing the first liquid crystal in the second display area.

Further, conditions for controlling the polymerization reaction include: a concentration of the monomers, a temperature of the polymerization reaction, a duration of the polymerization reaction, and irradiation intensity and an irradiation angle for irradiating the monomers.

Advantages of the present disclosure are that the present disclosure isolates the first display area (that is, the main screen display area) from the second display area (that is, the camera display area) by using a retaining wall of polymers (that is, organic molecules) instead of the existing frame sealant, and uses photomask exposure for polymerization to form a shape of the retaining wall. The retaining wall is correspondingly formed according to a difference between the boundaries of the first display area and the second display area. Parameters such as a irradiation duration, an irradiation intensity and an irradiation angle for polymerization of the monomers, duration of the polymerization reaction, and a temperature of the polymerization reaction, are controlled to prepare a retaining wall with a degree of cross-linking of more than 90% and a thickness of less than 50 micrometers, in order to visually eliminate the black border effect (black border caused by the excessively wide traditional frame sealant) at the boundary between the first display area and the second display area.

### BRIEF DESCRIPTION OF DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

FIG. 1 is a schematic structural diagram of a display panel according to an embodiment of the present disclosure.

FIG. 2 is a schematic plan diagram of a display panel according to an embodiment of the present disclosure.

FIG. 3 is a schematic flowchart of a method of manufacturing a display panel according to an embodiment of the present disclosure.

FIG. 4 is a process flowchart corresponding to the step S310 shown in FIG. 3.

FIG. 5 is a process flowchart corresponding to the step S320 shown in FIG. 3.

FIG. 6 is a process flowchart corresponding to the step S330 shown in FIG. 3.

FIG. 7 is a process flowchart corresponding to the step S340 shown in FIG. 3.

FIG. 8 is a process flowchart corresponding to the step S350 shown in FIG. 3.

FIG. 9 is a process flowchart corresponding to the step S360 shown in FIG. 3.

FIG. 10 is a flowchart of steps subsequent to the step S340 in another embodiment of the present disclosure.

FIG. 11 is a molecular structural formula of 4,4′-di[6-(acryloyloxy) hexyloxy]biphenyl provided in an embodiment of the present disclosure.

### DETAILED DESCRIPTION OF PREFERRED EMBODIMENTS

The technical solutions in the embodiments of the present application will be clearly and completely described in the following Referring to the accompanying drawings in the embodiments. It is apparent that the described embodiments are only a part of the embodiments of the present application, and not all of them. All other embodiments obtained by a person skilled in the art based on the embodiments of the present application without creative efforts are within the scope of the present application.

In the description of the present invention, it is to be understood that the terms “center”, “longitudinal”, “transverse”, “length”, “width”, “thickness”, “upper”, “lower”, “front”, “post”, “left”, “right”, “vertical”, “horizontal”, “top”, “bottom”, “inside”, “outside”, etc. demonstrating the orientation or positional relationship of the indications is based on the orientation shown in the drawings Or, the positional relationship is merely for the convenience of the description of the present invention and the simplification of the description, and is not intended to imply that the device or the component of the present invention has a specific orientation and is constructed and operated in a specific orientation, thus being not to be construed as limiting the present invention.

Moreover, the terms “first” and “second” are used for descriptive purposes only and are not to be construed as indicating or implying a relative importance or not to implicitly indicate a number of technical features indicated. Thus, features defined by “first” or “second” may include one or more of the described features either explicitly or implicitly. In the description of the present invention, the meaning of “a plurality” is two or more unless specifically defined otherwise.

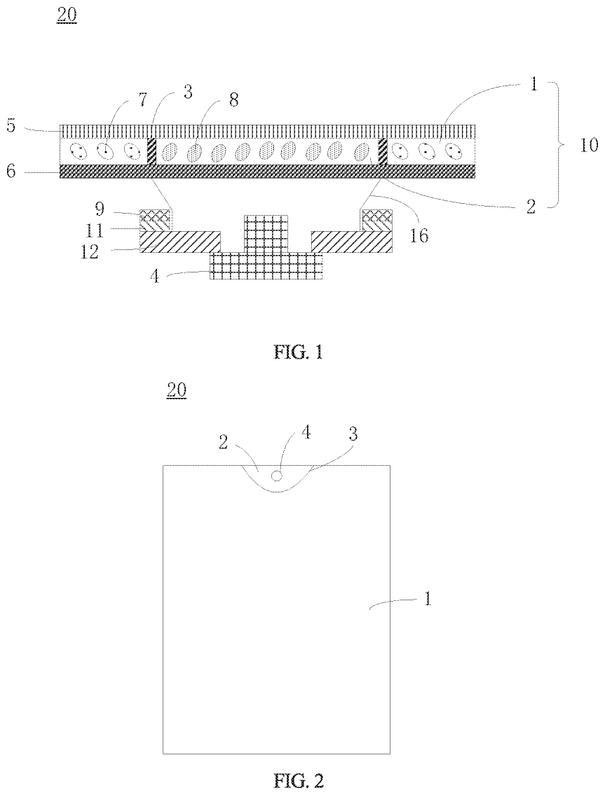

As shown in FIG. 1, FIG. 1 is a schematic structural diagram of a display panel according to an embodiment of the present disclosure. The display panel 20 includes: an array substrate 6, a color filter substrate 5, and a liquid crystal layer 10.

The array substrate 6 and the color filter substrate 5 are assembled as a cell, to form a display area of the display panel 20.

Referring to FIG. 2, the liquid crystal layer 10 includes a first liquid crystal layer 1 and a second liquid crystal layer 2, wherein the first liquid crystal layer 1 is spaced from the second liquid crystal layer 2 through a retaining wall 3; an area where the first liquid crystal layer 1 is located corresponds to a first display area of the display panel 20, and an area where the second liquid crystal layer 2 is located corresponds to a second display area of the display panel 20; and wherein the first display area is a main screen display area, a second display area is a display area of a camera 4 (i.e., a secondary screen display area), and the first display area and the second display area constitute the display area of the display panel.

In this embodiment, a light source module that provides a light source for the second display area includes a light guide ring 16, a light-enhancing layer 9, a diffusion layer 11, and a light-emitting layer 12. Specifically, the diffusion layer 11 is disposed on the light-emitting layer 12, and the light-enhancing layer 9 is disposed on the diffusion layer 11. The light guide ring 16 is embedded within the light-enhancing layer 9, the diffusion layer 11, and the light-emitting layer 12. The light-enhancing layer 9 is configured to improve the irradiation brightness, and the diffusion layer 11 is configured to evenly distribute the light. Further, the light-emitting layer 12 uses a mini-LED as a light source, but is not limited thereto. In this embodiment, the light guide ring 16 adopts, for example, a circular table structure, which is configured to ensure that light from the mini-LED can enter the light guide ring. In addition, it should be noted that the light-emitting layer 12 is disposed on a camera 4, and the camera 4 can be installed in a display device (such as a mobile phone).

Referring to FIG. 11, the retaining wall 3 is made of a material including non-polar or weakly polar aromatic organic molecules. In this embodiment, the aromatic organic molecules include methacrylate oligomers and 4,4′-di[6-(acryloyloxy)hexyloxy]biphenyl having a molecular structure formula as shown in FIG. 11. However, in other embodiments, the aromatic organic molecules are not limited thereto.

A shape of the retaining wall 3 is selected from one of a circle, a semi-arc, and a trapezoid. Specifically, when a blind hole screen is used as the display area of the display panel, a circular retaining wall 3 needs to be formed at the boundary between the first display area and the second display area. When the display area of the display panel is a water drop screen, a semi-arc retaining wall 3 needs to be formed at the boundary between the first display area and the second display area. When a cutout screen is used as the display area of the display panel, a trapezoidal retaining wall 3 needs to be formed at the boundary between the first display area and the second display area. Of course, when different display screens are used for the display panel, the retaining wall 3 formed at the boundary between the first display area 1 and the second display 2 needs to be formed to have a corresponding shape.

A width (the distance indicated by a reference numeral d in FIG. 8) of a vertical projection of the retaining wall 3 in a direction of the liquid crystal layer is smaller than a preset width threshold. In this embodiment, it is, for example, 50 micrometers. It has been found through research that the human eye cannot distinguish a retaining wall 3 with a thickness of less than 300 micrometers. Therefore, the black border effect (black border caused by the excessively wide traditional frame sealant) at the boundary between the first display area and the second display area can be visually eliminated.

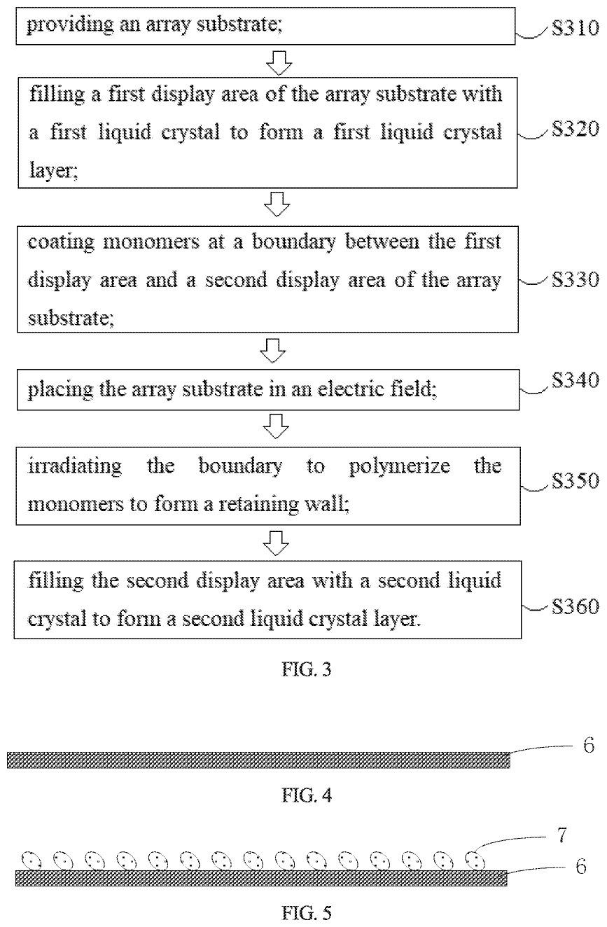

As shown in FIG. 3, FIG. 3 a schematic flowchart of a method of manufacturing a display panel according to an embodiment of the present disclosure, and the method of manufacturing a display panel includes the following steps:

Referring to FIG. 4, step S310: providing an array substrate 6.

Referring to FIG. 5, step S320: filling the first display area (the area where the first liquid crystal layer 1 is located) of the array substrate 6 with the first liquid crystal 7 to form a first liquid crystal layer 1.

The first liquid crystal 7 is made of a common liquid crystal material, and the first display area is a main screen display area.

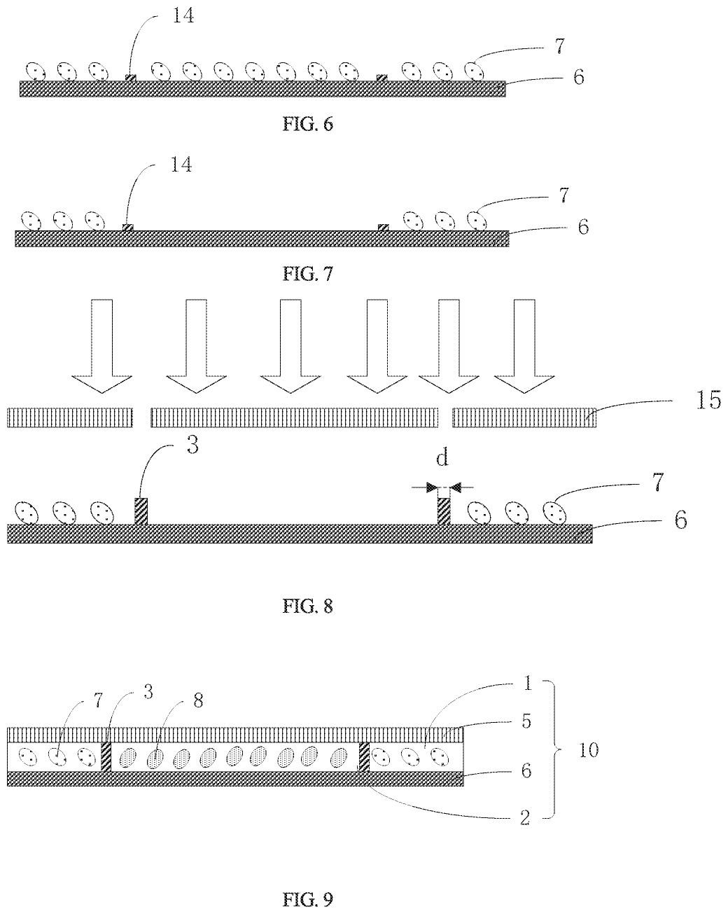

Referring to FIG. 6, step S330: coating monomers at a boundary between the first display area and the second display area (the area where the second liquid crystal layer 2 is located) of the array substrate 6.

The second display area is a display area of the camera 4, that is, a secondary screen display area.

Referring to FIG. 7, step S340: placing the array substrate 1 in an electric field.

The first liquid crystal 7 is applied with an electric field force using a specific electric field, and the retaining wall 3 is made of a material including non-polar or weakly polar aromatic organic molecules, which are less impacted by the electric field. Therefore, only the first liquid crystal 7 is subjected to the electric field force, and is moved from the second display region to the first display region by the electric field force.

Referring to FIG. 8, step S350: irradiating the boundary to polymerize the monomers to form a retaining wall 3.

Ultraviolet irradiation is performed at the boundary between the first display area and the second display area of the display panel with a photomask 15, causing the monomers to undergo a polymerization reaction.

Conditions for controlling the polymerization reaction include: a concentration of the monomers, a temperature of the polymerization reaction, a duration of the polymerization reaction, and irradiation intensity and an irradiation angle for irradiating the monomers (for example, diffracting light in a range of 10°) to prepare a retaining wall with a degree of cross-linking of more than 90% and a thickness of less than 50 micrometers, in order to visually eliminate the black border effect (black border caused by the excessively wide traditional frame sealant) at the boundary between the first display area and the second display area.

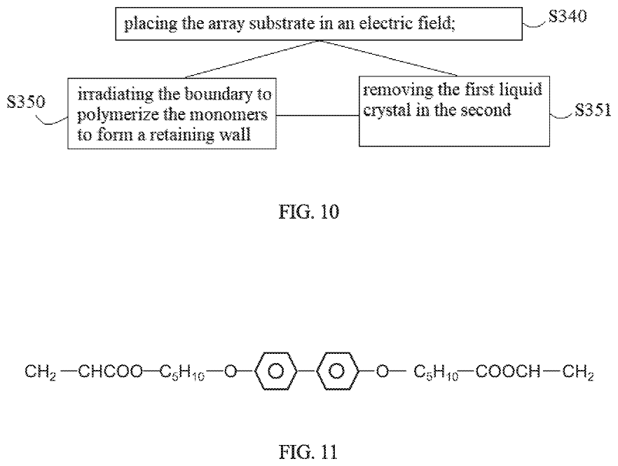

Referring to FIG. 10, FIG. 10 is a flowchart of steps subsequent to the step S340. After performing the step S340, while performing the step S350, the step S351 may be performed to remove the first liquid crystal 7 in the second display area, and this step is optional.

Specifically, the step of exposing the boundary to polymerize the organic molecules to form the retaining wall further includes: removing the first liquid crystal 7 in the second display area.

In the step S350, a small amount of the first liquid crystal 7 may flow into the second display area during the polymerization reaction. Therefore, the step S351 can be performed to further remove the first liquid crystal 7 in the second display area. After performing the step S351, the step S350 may be continued.

Referring to FIG. 9, the step S360: filling the second display area with a second liquid crystal 8 to form a second liquid crystal layer 2.

The second liquid crystal 8 includes a polymer network liquid crystal (PNLC) or a polymer dispersed liquid crystal (PDLC), but is not limited thereto.

Advantages of the present disclosure are that the present disclosure isolates the first display area (that is, the main screen display area) from the second display area (that is, the camera display area) by using a retaining wall of polymers (that is, organic molecules) instead of the existing frame sealant, and use photomask exposure for polymerization to form a shape of the retaining wall. The retaining wall is correspondingly formed according to a difference between the boundaries of the first display area and the second display area. Parameters such as a irradiation duration, an irradiation intensity and an irradiation angle for polymerization of the monomer, duration of the polymerization reaction, and a temperature of the polymerization reaction, are controlled to prepare a retaining wall with a degree of cross-linking of more than 90% and a thickness of less than 50 micrometers, in order to visually eliminate the black border effect (black border caused by the excessively wide traditional frame sealant) at the boundary between the first display area and the second display area.

While the invention has been described by way of example and in terms of the preferred embodiments, it is to be understood that the invention is not limited to the disclosed embodiments. To the contrary, it is intended to cover various modifications and similar arrangements. Therefore, the scope of the appended claims should be accorded the broadest interpretation so as to encompass all such modifications and similar arrangements.

The subject matter of the present disclosure can be manufactured and used in industry and has industrial applicability.

What is claimed is:

1. A display panel, comprising:
a liquid crystal layer, comprising a first liquid crystal layer and a second liquid crystal layer, wherein the first liquid crystal layer is spaced from the second liquid crystal layer through a retaining wall; an area where the first liquid crystal layer is located corresponds to a first display area of the display panel, and an area where the second liquid crystal layer is located corresponds to a second display area of the display panel; and
wherein a width of a vertical projection of the retaining wall in a direction of the liquid crystal layer is smaller than a preset width threshold.

2. The display panel according to claim 1, wherein the retaining wall is made of a material comprising non-polar or weakly polar aromatic organic molecules.

3. The display panel according to claim 2, wherein the aromatic organic molecules are methacrylate-based oligomers and 4,4′-di[6-(acryloyloxy)hexyloxy]biphenyl.

4. The display panel according to claim 1, further comprising:
an array substrate; and
a color filter substrate, the color filter substrate is disposed opposite to the array substrate;
the liquid crystal layer is sandwiched between the array substrate and the color filter substrate; the liquid crystal layer is divided into the first display area and the second display area by the retaining wall, wherein the area enclosed by the retaining wall is the second display area.

5. The display panel according to claim 1, wherein a shape enclosed by the retaining wall is selected from one of a circle, a semi-arc and a trapezoid.

6. The display panel according to claim 1, wherein the preset width threshold is smaller than or equal to 50 microns.

7. A method of manufacturing a display panel, comprising the following steps:
providing an array substrate;
filling a first display area of the array substrate with a first liquid crystal to form a first liquid crystal layer;
coating monomers at a boundary between the first display area and a second display area of the array substrate;
placing the array substrate in an electric field;
irradiating the boundary to polymerize the monomers to form a retaining wall; and
filling the second display area with a second liquid crystal to form a second liquid crystal layer.

8. The method of manufacturing the display panel according to claim 7, wherein the retaining wall is made of a material comprising non-polar or weakly polar aromatic organic molecules, and the aromatic organic molecules are methacrylate-based oligomers and 4,4′-di[6-(acryloyloxy)hexyloxy]biphenyl.

9. The method of manufacturing the display panel according to claim 7, wherein the step of irradiating the boundary to polymerize the monomers to form a retaining wall further comprises:
removing the first liquid crystal in the second display area.

10. The method of manufacturing a display panel according to claim 7, wherein conditions for controlling the polymerization reaction comprise: a concentration of the monomers, a temperature of the polymerization reaction, a duration of the polymerization reaction, and irradiation intensity and an irradiation angle for irradiating the monomers.
